(19) United States
(12) Patent Application Publication
(10) Pub. No.: US 2007/0009703 A1
(43) Pub. Date: Jan. 11, 2007

(54) Optical recording medium and two layered optical recording medium, recording and reproducing method and recording and reproducing apparatus using media

(76) Inventors: Masaru Shinkai, Yokohama-shi (JP); Michiaki Shinotsuka, Hiratsuka-shi (JP); Hiroyuki Iwasa, Yokohama-shi (JP)

Correspondence Address: Mark J. Thronson;Dickstein Shapiro Morin & Oshinsky LLP, 2101 L Street, N.W., Washington, DC, 20037-1526, US

(21) Appl. No.: 11/520,756

(22) Filed: Sep. 14, 2006

Related U.S. Application Data
(63) Continuation of application No. PCT/JP05/05459, filed on Mar. 17, 2005.

(30) Foreign Application Priority Data
Mar. 18, 2004 (JP) 2004-078370

(51) Int. Cl. B32B 3/02

(52) U.S. Cl. 428/64.4

(57) ABSTRACT

The present invention provides an optical recording medium comprising a transparent first substrate and a first dielectric layer, a recording layer, a second dielectric layer and a reflective layer which are laminated on the first substrate in this order, wherein the recording layer comprises a thin layer comprising mainly an alloy represented by the composition formula: GeₓSb_{y}Te_{z} (wherein x, y and z represent respectively an atomic %, and x, y and z satisfy respectively the following equations: 3.5≦x≦10, 70≦y≦80 and z=100−x−y) and the second dielectric layer comprises a thin film of a compound oxide comprising at least one of a mixture of Nb₂O₅ and ZrO₂, a mixture of Nb₂O₅ and ZnO and a mixture of Nb₂O₅, ZrO₂ and ZnO.

### CROSS-REFERENCE TO RELATED APPLICATIONS

This is a continuation of Application No. PCT/JP2005/005459, filed on Mar. 17, 2005.

### BACKGROUND OF THE INVENTION

1. Field of the Invention

The present invention relates to an optical recording medium (hereinafter, sometimes referred to as “optical information recording medium”, “phase-changing optical recording medium” or “phase-changing optical information recording medium”) and a two layered optical recording medium (hereinafter, sometimes referred to as “two layered optical information recording medium”, “two layers phase-changing optical recording medium” or “two layers phase-changing optical information recording medium”), which are excellent in environmental resistance, when they comprise in the reflective layer Ag or an Ag alloy as well as a recording and reproducing method and a recording and reproducing apparatus using the above-noted optical recording media.

2. Description of the Related Art

Among the optical recording discs, a phase-changing optical recording disc usually has a layer composition comprising four layers, such as transparent plastic substrate/dielectric material layer/chalcogen phase-changing recording material layer/dielectric material layer/metal reflective layer. As the dielectric material, a mixture of ZnS and SiO₂ (in mixing molar ratio % of 80:20) is most frequently used. The dielectric material has the following functions: (1) protecting the substrate from the heat generated in the recording layer which is momentarily elevated to a temperature of the melting point of the substrate or higher and preventing the deformation and breakage of the recording layer when the heating temperature of the recording layer is elevated to the melting point or higher (2) obtaining a satisfactory signal strength by the optical interference effect during the reproducing of the recorded information and (3) obtaining a sufficient cooling rate to forming an amorphous mark in an advantageous form during the recording. Therefore it is required that the dielectric material has such properties as a satisfactory heat-resistance, a large refractive index and a satisfactory thermal conductivity.

Conventional examples of the material satisfying the above-noted properties include various oxides, nitrides, chalcogenide compounds and a mixture thereof. As a background where a mixture of ZnS and SiO₂ is most frequently, there can be mentioned that the mixture not only has thermal properties and optical properties which are suitable for the optical information medium, but also can be shaped to the film with a remarkably high speed in comparison with other dielectric materials. In addition, as a background where ZnS is used in a mixture with SiO₂, there can be mentioned that since when ZnS is used individually as the material for the dielectric material layer, ZnS is crystallized and the dielectric material layer is caused to be brittle by subjecting the dielectric material layer to the irradiating of a laser and a thermal energy, for preventing that the dielectric material layer is caused to be brittle, ZnS is mixed with SiO₂ as the material for the dielectric material layer.

Next, as a material for the metal reflective layer, generally an Al alloy or an Ag alloy is used. In recent years, the higher the recording speed of the optical information medium becomes, the more frequently Ag or an Ag alloy is used as a material for the reflective layer. It is the reason for the frequent use of Ag or an Ag alloy that Ag or an Ag alloy has as a reflective layer a reflectivity of about 90% and Ag has an advantageous thermal conductivity of 428 W/m×K (at 100° C.), so that an amorphous recording mark can be formed in a short time. Particularly as a material for producing an optical information-recording medium comprising a phase-changing material of a Sb—Te eutectic crystal having a structure of Sb₇₀Te₃₀, in which an amorphous recording mark is formed by the rapid cooling, Ag or an Ag alloy is frequently used conventionally (see Japanese Patent Application Laid-Open (JP-A) No.2001-056958).

However, on the other hand, as a disadvantage of the Ag reflective layer, there can be mentioned that the Ag reflective layer has so poor environmental resistance that the Ag reflective layer is easily sulfurated in a sulfurative atmosphere. Conventional examples of a countermeasure for improving the poor environmental resistance of the Ag reflective layer include a method for disposing a barrier layer for the sulfuration resistance which comprises a carbide, between the Ag reflective layer and the dielectric material layer comprising a mixture of ZnS and SiO₂ (see JP-A No. 2002-74746), a method for disposing an intermediate layer comprising a metal, between the metal reflective layer and the dielectric layer (see JP-A No. 11-238253) and a method for preventing the sulfuration of the reflective layer by producing the reflective layer using not Ag but an Ag alloy which is said to have better corrosion-resistance than pure Ag (see R & D technical report of Kobe Steel, Ltd., Vol. 52, No. 2, (September 2002) (PP. 17-22)). However, as a new problem, it was found that even if by taking such countermeasures, a disadvantage is caused wherein a blotch pattern is rarely caused on the surface of the recording medium due to the environmental deterioration of Ag.

Further, since in recent years, the volume of the information which is recorded in a computer memory, a memory for an image file or a sound file and an optical memory card is extremely enlarged, the enlargement of the information recording capacity and the enhancement of the density of the signal information in the optical disc, such as DVD+R/RW, DVD-R/RW and DVD-RAM are proceeded.

At present, CD (Compact Disc) has a recording capacity of 650 MB and DVD (Digital Versatile Disc) has a recording capacity of 4.7 GB; however a furthermore higher recording density is required.

As a method for enhancing the recording density, it is studied that with respect to the optical system, the wavelength of the used semiconductor laser is shortened and the NA (Numerical Aperture) of the object lens is enlarged. Furthermore, besides a planar enhancement of the recording density, it is also studied that the recording layer is caused to comprise multiple layers in the thickness direction of the recording medium to enlarge the information recording capacity.

Examples of the problem when the recording layer comprises multiple layers include enlarging the amount of the light irradiated to the second recording layer which is located behind the first recording layer and securing light transmission properties of the first recording layer to enlarge the amount of the light reflected at the metal reflective layer which can be transmitted through the first recording layer. However, when for solving the above-noted problems, the thickness of the first recording layer is rendered to be extremely thin, the light transmission properties of the first recording layer is improved; however, the laser power absorbed in the first recording layer becomes less according to an enlarged amount of the light transmitted through the first recording layer, so that a disadvantage is caused wherein a sufficient recording signal difference to reading the signal cannot be obtained and therefore, there is a technically difficult problem in obtaining a multi-layer composition.

### SUMMARY OF THE INVENTION

The mechanism of corrosion of Ag or an Ag alloy used for producing the reflective layer of the optical information recording medium is not completely yet clarified; however it is generally thought that when the reflective layer is produced using Ag or an Ag alloy, Ag or an Ag alloy is sulfurated by sulfur-impurities in a dielectric layer comprising a mixture of ZnS and SiO₂, so that the reflective layer is deteriorated. Conventional examples of the countermeasure for preventing the deterioration of the reflective layer include, as noted above, a method for disposing a barrier layer comprising carbides or nitrides (see JP-A No.2002-74746) and a method for disposing an intermediate layer comprising a metal (see JP-A 11-238253). However, the present inventors have measured the optical extinction coefficient k and the optical transmittance of a barrier layer (or an intermediate layer) which is disposed in an optical recording medium of multi-layer type and it was found as the result of the measurement that the barrier layer (or the intermediate layer) had a high optical extinction coefficient k and a low optical transmittance, so that such a barrier layer is undesirable as the barrier layer disposed in the optical recording medium of multi-layer type for protecting the metal reflective layer. Measured optical extinction coefficients k of a barrier layer comprising an oxide, a barrier layer comprising a carbide or a nitride and an intermediate layer comprising a metal were respectively 10⁻³ to 10⁻⁴, 10⁻¹ to 10⁻² and 10⁰ to 10⁻¹.

Furthermore, with respect to the barrier layer comprising an oxide, which is disclosed in JP-A No.2002-74746, it was found that under a condition, while the barrier layer has advantageous light transmission properties, the barrier layer has sometimes an unsatisfactory function to protect the reflective layer comprising Ag or an Ag alloy. In other words, even though a barrier layer comprises an oxide, when the oxide has a composition in which the number of oxygen atoms is shortened from the standard composition of the oxide by ten atom-number ratio % or more, the barrier layer may contribute to the deterioration of Ag or an Ag alloy, irrespective of the presence of sulfur-impurities.

The cause thereof is so considered that the metal component having a lone electron which is not bonded to the electron of oxygen atom, becomes active relative to the environment; however a reliable mechanism is not yet clarified.

On the other hand, with respect to the two-layered optical recording medium, by distributing the amount of the laser beam evenly to the first recording layer and the second recording layer, not only the first recording layer which is located on the surface of the recording medium at which the light is irradiated can be recorded and reproduced, but also the second recording layer which is located behind the first recording layer can also be recorded and reproduced by a collected laser and for that purpose, particularly satisfactory light transmission properties of the first recording layer is required. However it was found that a barrier layer produced using a conventional material used for a barrier layer preventing the corrosion of Ag or an Ag alloy has unsatisfactory light transmission properties as the barrier layer in a satisfactory recording layers composition comprising plural recording layers.

In this situation, the present inventors have made extensive and intensive studies with respect to not only the barrier layer preventing the corrosion of the reflective layer comprising Ag or an Ag alloy, but also the barrier layer having advantageous light transmission properties for producing a recording layer composition comprising two recording layers.

Accordingly, it is an object of the present invention to provide an optical recording medium in which the corrosion of the reflective layer comprising Ag or an Ag alloy is prevented and particularly the sulfuration of the reflective layer which is caused by a mixture of ZnS and SiO₂ used as a dielectric material in a conventional optical information recording medium, is prevented. It is another object of the present invention with respect to the optical recording medium comprising two recording layers to equalize the properties and strength of the signal recording and reproducing of a recording layer and those of another recording layer.

The measures for solving the above-noted problems are as flows.

<1> An optical recording medium comprising:

a first substrate,

a first dielectric layer,

a recording layer,

a second dielectric layer, and

a reflective layer in this order,

wherein the recording layer comprises the composition represented by the composition formula: GeₓSb_{y}Te_{z} (wherein x, y and z represent respectively an atomic %, and x, y and z satisfy respectively the following equations: 3.5≦x≦10, 70≦y≦80 and z=100−x−y) and the second dielectric layer comprises a compound oxide comprising at least Nb₂O₅.

<2> The optical recording medium according to the item <1> above,

wherein the amount of Nb₂O₅ in the second dielectric layer is mole % or more.

<3> The optical recording medium according to any one of items <1> to <2> above,

wherein the second dielectric layer comprises at least one of ZrO₂ and ZnO.

<4> The optical recording medium according to any one of items <1> to <3> above,

wherein the second dielectric layer comprises any one of a mixture of Nb₂O₅ and ZrO₂ and a mixture of Nb₂O₅ and ZnO.

<5> The optical recording medium according to any one of items <1> to <4> above,

wherein the second dielectric layer comprises at least two layers and a layer of the two layers which is contacted with the reflective layer comprises a compound oxide comprising at least Nb₂O₅ and another layer of the two layers which is not contacted with the reflective layer comprises another dielectric material than Nb₂O₅, ZrO₂ and ZnO.

<6> The optical recording medium according to any one of items <1> to <5> above,

wherein a layer of the second dielectric layer which is contacted with the reflective layer has a thickness of 3 nm or more.

<7> The optical recording medium according to any one of items <1> to <6> above,

wherein the second dielectric layer has a total thickness of 10 nm to 30 nm.

<8> The optical recording medium according to any one of items <1> to <7> above,

wherein a crystalline phase of the recording layer is in at least one of an unrecorded state and an erased state and an amorphous phase of the recording layer is in a recorded state.

<9> The optical recording medium according to any one of items <1> to <8> above,

wherein the recording layer has a thickness of 5 nm to 16 nm.

<10> The optical recording medium according to any one of items <1> to <9> above,

wherein the reflective layer comprises at least one of Ag and an Ag alloy.

<11> A two-layered optical recording medium comprising:
a first information layer which comprises:
   a first substrate,
   a first dielectric layer,
   a first recording layer,
   a second dielectric layer, and
   a first reflective layer in this order;
   an intermediate layer; and
a second information layer which comprises:
   a second substrate,
   a second reflective layer,
   a fourth dielectric layer,
   a second recording layer, and
   a third dielectric layer in this order,

wherein the first reflective layer of the first information layer is disposed on a surface of the intermediate layer and the second reflective layer of the second information layer is disposed on another surface of the intermediate layer,

and wherein the first recording layer and the second recording layer comprise a composition represented by the formula: GeₓSb_{y}Te_{z} (wherein x, y and z represent respectively an atomic % and x, y and z satisfy respectively the following equations: 3.5≦x≦10, 70≦y≦80 and z=100−x−y) and the second dielectric layer and the fourth dielectric layer comprise a compound oxide comprising at least Nb₂O₅.

<12> The two-layered optical recording medium according to item <11> above,

wherein the amount of Nb₂O₅ in the second dielectric layer or in the fourth dielectric layer is 50 mole % or more.

<13> The two-layered optical recording medium according to any one of items <11> to <12> above,

wherein the second dielectric layer and the fourth dielectric layer comprise at least one of ZrO₂ and ZnO.

<14> The two-layered optical recording medium according to any one of items <11> to <13> above,

wherein the second dielectric layer and the fourth dielectric layer comprise any one of a mixture of Nb₂O₅ and ZrO₂ and a mixture of Nb₂O₅ and ZnO.

<15> The two-layered optical recording medium according to any one of items <11> to <14> above,

wherein the second dielectric layer comprises at least two layers and a layer of the second dielectric layer which is contacted with the first reflective layer comprises a compound oxide comprising at least Nb₂O₅ and another layer of the second dielectric layer which is not contacted with the first reflective layer comprises another dielectric material than Nb₂O₅, ZrO₂ and ZnO.

<16> The two-layered optical recording medium according to any one of items <11> to <15> above,

wherein the fourth dielectric layer comprises at least two layers and a layer of the fourth dielectric layer which is contacted with the second reflective layer comprises a compound oxide comprising at least Nb₂O₅ and another layer of the fourth dielectric layer which is not contacted with the second reflective layer comprises another dielectric material than Nb₂O₅, ZrO₂ and ZnO.

<17> The two-layered optical recording medium according to any one of items <11> to <16> above,

wherein a layer of the second dielectric layer which is contacted with the first reflective layer and a layer of the fourth dielectric layer which is contacted with the second reflective layer have a thickness of 3 nm or more.

<18> The two-layered optical recording medium according to any one of items <11> to <17> above,

wherein at least one of the second dielectric layer and the fourth dielectric layer has a total thickness of 10 nm to 30 nm.

<19> The two-layered optical recording medium according to any one of items <11> to <18> above,

wherein a crystalline phase of the recording layer is in an unrecorded state and an amorphous phase of the recording layer is in a recorded state.

<20> The two-layered optical recording medium according to any one of items <11> to <19> above,

wherein the first recording layer has a thickness of 5 nm to 12 nm and the second recording layer has a thickness of 5 nm to 16 nm.

<21> The two-layered optical recording medium according to any one of items <11> to <20> above,

wherein both the first recording layer and the second recording layer have a reflectance of 4% to 10%.

<22> The two-layered optical recording medium according to any one of items <11> to <21> above,

wherein at least one of the first reflective layer and the second reflective layer comprises at least one selected from the group consisting of Ag, Pd, Pt, Au, and an alloy thereof.

<23> A recording and reproducing method of an optical recording medium comprising:

performing at least one of the recording and reproducing of the information by irradiating a laser beam from the first substrate to the recording layer of the optical recording medium according to any one of items <1> to <10> above.

<24> A recording and reproducing method of a two-layered optical recording medium comprising:

performing at least one of the recording and reproducing of the information by irradiating a laser beam from the first substrate to the recording layer of the optical recording medium according to any one of items <11> to <22> above.

<25> An optical recording and reproducing apparatus comprising:

a light source from which a laser beam is irradiated to an optical recording medium for performing at least one of the recording and reproducing of the information in the optical recording medium,

wherein the optical recording medium is the optical recording medium according to any one of items <1> to <22> above.

### BRIEF DESCRIPTION OF THE DRAWINGS

FIG. 1 is a sectional view schematically exemplifying the layer composition of the two-layered optical recording medium which comprises the second dielectric layer comprising a single layer and the recording layer comprising a single layer.

FIG. 2 is a sectional view schematically exemplifying the layer composition of the two-layered optical recording medium which comprises the second dielectric layer comprising a single layer, the fourth dielectric layer comprising a single layer and the recording layer comprising two layers.

FIG. 3 is a sectional view schematically exemplifying the layer composition of the two-layered optical recording medium which comprises the second dielectric layer comprising plural layers (in FIG. 3 two layers) and the recording layer comprising two layers.

FIG. 4 is a sectional view schematically exemplifying the layer composition of the two-layered optical recording medium which comprises the second dielectric layer comprising plural layers (in FIG. 4 two layers) and the recording layer comprising two layers.

FIG. 5 is a graph showing R, T, and A (R: reflectance, T: transmittance, A: absorbance) of monolayers of various materials for the reflective layer.

FIG. 6 is a graph showing the reflectance and the initial jitter of the two-layered optical recording medium according to Example 17.

FIG. 7 is a triangular chart showing a range of the compositions applicable for the recording material.

FIG. 8 is a triangular chart showing the recording material compositions of Examples 2, 19-26, and Comparative Examples 12-15.

FIG. 9 is a graph showing the initial jitters of L0 and L1 of the two-layered optical recording mediums according to Example 27.

### DESCRIPTION OF THE PREFERRED EMBODIMENTS

(Optical Recording Medium and Two-Layered Optical Recording Medium)

The optical recording medium according to the present invention comprises a first substrate, a first dielectric layer disposed on the first substrate, a recording layer disposed on the first dielectric layer, a second dielectric layer disposed on the recording layer and a reflective layer disposed on the second dielectric layer and the second dielectric layer comprises a compound oxide comprising at least Nb₂O₅.

The second dielectric layer contacted with the reflective layer preferably comprises a layer having a thickness of 10 nm to 30 nm which comprises at least one of a mixture of Nb₂O₅ and ZrO₂, a mixture of Nb₂O₅ and ZnO and a mixture of Nb₂O₅, ZrO₂ and ZnO.

The two-layered optical recording medium according to the present invention comprises a first information layer comprising a first substrate, a first dielectric layer, a first recording layer, a second dielectric layer and a first reflective layer in this order; an intermediate layer; and a second information layer comprising a second substrate, a second reflective layer, a fourth dielectric layer, a second recording layer and a third dielectric layer in this order,

wherein the first reflective layer of the first information layer is disposed on a surface of the intermediate layer and the second reflective layer of the second information layer is disposed on another surface of the intermediate layer,

and wherein the second dielectric layer and the fourth dielectric layer comprise a compound oxide comprising at least Nb₂O₅.

More specifically, the second dielectric layer and the fourth dielectric layer which are contacted with the reflective layer comprises a layer having a thickness of 10 nm to 30 nm which comprises at least one of a mixture of Nb₂O₅ and ZrO₂, a mixture of Nb₂O₅ and ZnO and a mixture of Nb₂O₅, ZrO₂ and ZnO.

In the recording layer of the above-noted optical recording media, the information can be recorded with a crystalline phase in an unrecorded and erased state, an amorphous phase in a recorded state and plural recording marks having the shortest mark length of 0.03 μm or more. In other words, the length of a formed recording mark is calculated according to such a simplified calculation that the mark length 0.26 μm of a plural-values recording medium having NA 0.65 is divided by 7 into 0.037 μm, so that a recording mark having a length of 0.037 μm will be formed according to the calculation. The length of a recording mark formed actually in a recording medium was measured by a transmission electron microscope and was found to be 0.03 μm in terms of the shortest length. When a recording mark having the shortest length of 0.03 μm can be read and recorded, a recording medium having a recording capacity of 25 GB can be obtained. The shorter the shortest mark length becomes, the higher the recording density becomes; however, according to the CD standard for a two values recording medium, the shortest mark length is 1.87 μm.

At least the recording layer and the first recording layer are a thin layer having a thickness of 5 nm to 16 nm which comprises mainly an alloy represented by a composition formula: GeₓSb_{y}Te_{z} (wherein x, y and z represent respectively an atomic % and x, y and z satisfy respectively the following equations: 3.5≦x≦10, 70≦y≦80 and z=100−x−y). Here, “the recording layer comprises mainly an alloy” means “the recording layer comprises 50% by mass or more of an alloy, based on the mass of the recording layer” and “the recording layer comprises an alloy in at least an amount which is required for the recording and reproducing of the recording medium”; however, usually, the recording layer comprises preferably 90% by mass or more of an alloy, more preferably 95% by mass or more of an alloy, based on the mass of the material (a phase-changing material) of the recording layer. In other words, “the phase-changing material (the recording layer) comprises mainly an alloy represented by a composition formula: GeₓSb_{y}Te_{z} (wherein x, y and z represent respectively an atomic % and x, y and z satisfy respectively the following equations: 3.5≦x≦10, 70≦y≦80 and z=100−x−y)” means “the phase-changing material (the recording layer) comprises at least Ge, Sb and Te, wherein the total amount of Ge, Sb and Te is at least 50% by mass, based on the mass of the phase-changing material (the recording layer) and the relationship among the atomic %s of Ge, Sb and Tb satisfies the tree equations in the parenthesis.

Sb₇₀Te₃₀ (atomic %), which is the eutectic composition of Sb and Sb₂Te₃, has a melting point of 54° C. that is low as a composition of Sb and Te. When Sb₇₀Te₃₀ is used as a material for a recording layer of an optical recording medium, it is therefore preferable since such the composition can be sufficiently fused by the semiconductor laser light, and the ratio C/N of appropriately 50 dB can be attained. However, the stability of the amorphous marks becomes a problem for such the composition as it has a low melting point. To attain reliability, 1 atomic % to 2 atomic % of Ge is generally added to Sb₇₀Te₃₀ as a stabilizer.

In the composition of the present invention, as 70 atomic % or more of Sb is contained therein, it is necessary to add more than 3.5 atomic % of Ge so as to maintain stability. Since the large amount of Ge is added, the light intensity of reproducing light is enhanced, and thus it is easier to attain wide dynamic range and modulation. If the addition amount of Ge is further increased, the melting point is increased to thereby stabilize the amorphous marks on one hand, but it becomes harder to form a mark by a semiconductor laser light so that the photosensitivity of the recording layer is lowered on the other hand. Therefore, the addition amount of Ge is set as 10 atomic % or less.

If the addition amount of Sb is larger, the recording speed can be increased. Therefore, it is not necessary to dispose an interference layer which induce crystallization by contacting the recording layer, and the optical recording medium can be composed with a small number of layers. For this reason, the addition amount of Sb is set as 70 atomic % or more. However, it is not preferable to add more than 80 atomic % of Sb, since the properties of the composition become more close to those of Sb itself, and crystallization temperature is rapidly decreased. In such case, the stability of the amorphous marks is lowered even with an addition of Ge, and thus the reliability thereof is lowered.

The addition amount of Te is appropriately adjusted so that the total composition amount becomes 100 atomic %.

In the case where the thickness of the recording layer is less than 5 nm, the recording cannot be performed with a low jitter. In the case where the thickness of the recording layer is more than 16 nm, the recording cannot be performed with a low jitter. In the case of the first recording layer of the two-layered optical recording medium, the thickness is preferably from 5 nm to 12 nm. In the case the thickness of the first recording layer is more than 12 nm, the irradiance of the laser light to the second recording layer, which is present further in the structure of the optical recording medium relative to the light source, becomes insufficient, and thus the second recording layer cannot be recorded with a low jitter.

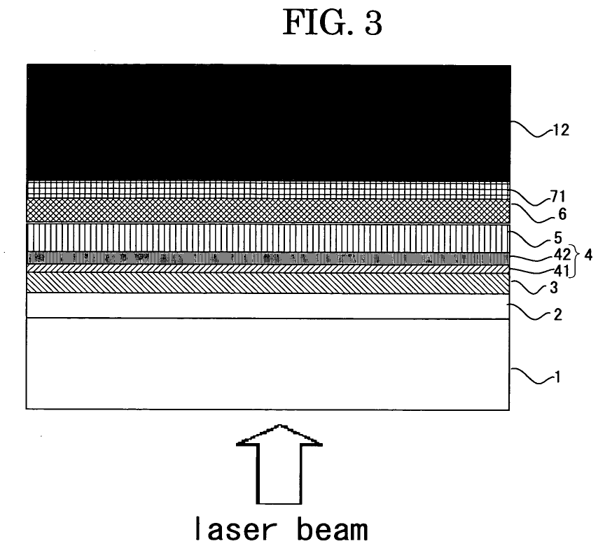

Further, the two-layered optical recording medium according to the present invention is produced, as shown in FIG. 3 in such a manner that the dielectric layer disposed on the reflective layer comprises plural layers, wherein a layer among the plural layers which is contacted with the reflective layer is a layer having a thickness of 3 nm or more which comprises a compound oxide comprising at least one of a mixture of Nb₂O₅ and ZrO₂, a mixture of Nb₂O₅ and ZnO and a mixture of Nb₂O₅, ZrO₂ and ZnO and at least one layer among the above-noted plural layers which is not contacted with the reflective layer comprises another dielectric material than the above-noted compound oxide, so that with respect to the above-noted two-layered recording medium according to the present invention, the shelf reliability can be obtained without changing largely conventional recording conditions.

Since it is necessary that a layer among plural layers of the dielectric layer which is contacted with the reflective layer has not only light transmission properties but also the barrier function to prevent the corrosion and deterioration of the reflective layer comprising Ag or an Ag alloy, an oxide is used as the material for the above-noted layer of the dielectric layer according to the present invention. In addition, when an oxide having a high melting point of 550° C. or higher is used, the adhesion properties between the reflective layer comprising of Ag or an Ag alloy and the recording layer. For preventing the crystallization of the layer of the dielectric layer which is subjected to a thermal energy generated by irradiating a laser beam to the layer, it is preferred to use a compound oxide comprising two types or more of the metal as a material for the layer of the dielectric layer. Further, as an oxide material for the layer of the dielectric layer, an oxide material comprising another metal than a metal having an unpaired electron which is not bonded to an electron of the oxygen atom, i.e., an oxide material which doesn't easily lose the oxygen atom, when the oxide material is shaped to an oxide thin film, should be selected. Examples of such an oxide material include ZnO and ZrO₂. When an oxide material losing easily the oxygen atom is used, a disadvantage is caused wherein the transparency of the oxide thin film is lowered due to losing the oxygen atom and when for solving this disadvantage oxygen gas is introduced into an inert gas used for the sputtering for the formation of the oxide thin film, almost always, the film formation rate is lowered and consequently the productivity of the recording medium is lowered. Accordingly, the production method of the layer of the dielectric layer using an oxide material which doesn't easily lose the oxygen atom doesn't need a reactive sputtering introducing oxygen, so that the method is advantageous in the productivity of the recording medium. Further, in the production method comprising a reactive sputtering introducing oxygen, when the introduced oxygen is remained in the oxide thin film, it is feared that the residual oxygen may promote the sulfuration of the reflective layer comprising Ag or an Ag alloy.

Examples of the oxide material include besides ZnO and ZrO₂, Nb₂O₅. Nb₂O₅ has a high refractive index, a low thermal capacity and a film formation rate of 1.8 nm/sec·kW to 2.1 nm/sec·kW which is relative high among oxides.

From the above-noted viewpoints, according to the present invention, the layer of the dielectric layer contacted with the reflective layer is produced by comprising a compound oxide which comprises at least one of a mixture of Nb₂O₅ and ZrO₂, a mixture of Nb₂O₅ and ZnO and a mixture of Nb₂O₅, ZrO₂ and ZnO. From the viewpoint of securing the film formation rate of the dielectric layer, the amount of Nb₂O₅ in the second or fourth dielectric layer is preferably 50 mole % or more, more preferably from 50 mole % to 95 mole % and it is preferred that a molar ratio between Nb₂O₅ and one of ZrO₂ and ZnO in the second or fourth dielectric layer is 50 mole %:50 mole % to 95 mole %:5 mole %. When the amount of Nb₂O₅ is more than 95 mole %, the above-noted film formation rate becomes similar to that of the dielectric layer comprising 100 mole % of Nb₂O₅, so that it is considered that the dielectric layer comprising more than 95 mole % of Nb₂O₅ is easily crystallized, when it is shaped to a film. Therefore, it is preferred that the amount of Nb₂O₅ is 95 mole % or less.

Hereinbelow, with respect to the above-noted each layer, explanations are given with referring to FIGs.

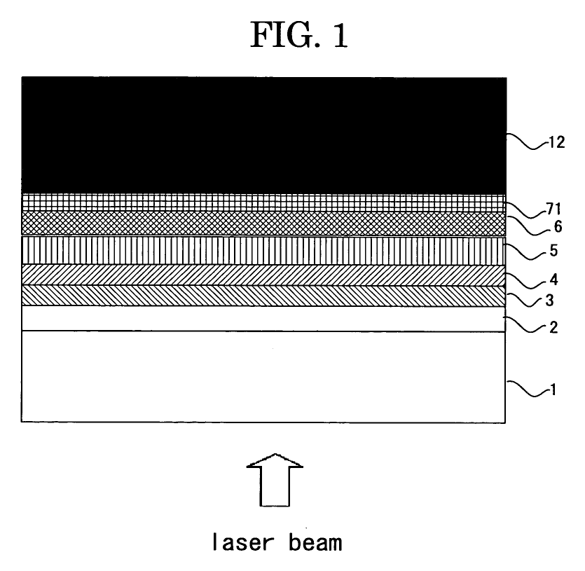

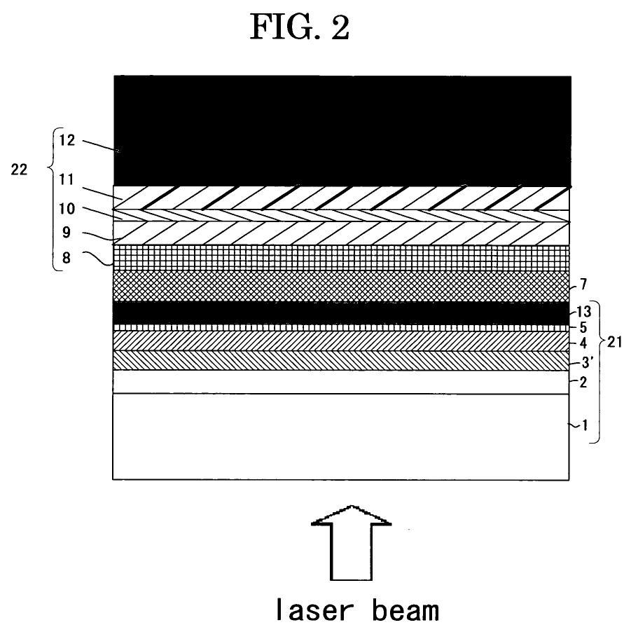

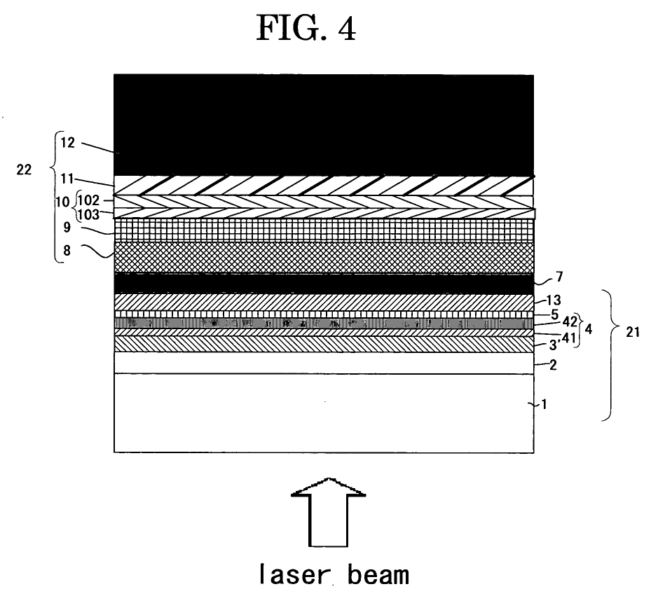

FIG. 1 is a sectional view schematically exemplifying the layer composition of the two-layered optical recording medium which comprises the second dielectric layer comprising a single layer and the recording layer comprising a single layer. FIG. 2 is a sectional view schematically exemplifying the layer composition of the two-layered optical recording medium which comprises the second dielectric layer comprising a single layer, the fourth dielectric layer comprising a single layer and the recording layer comprising two layers. FIG. 3 is a sectional view schematically exemplifying the layer composition of the two-layered optical recording medium which comprises the second dielectric layer comprising plural layers (in FIG. 3 two layers) and the recording layer comprising two layers. FIG. 4 is a sectional view schematically exemplifying the layer composition of the two-layered optical recording medium which comprises the second dielectric layer comprising plural layers (in FIG. 4 two layers) and the recording layer comprising two layers. In the FIGs., 1 represents the transparent first substrate, 2 represents the first dielectric layer, 3 represents the recording layer, 3′ represents the first recording layer, 4 represents the second dielectric layer, 41 represents a layer of the second dielectric layer, which is disposed on the surface of the recording layer, 42 represents a layer of the second dielectric layer, which is disposed on the surface of the reflective layer, 5 represents the first reflective layer, 6 represents the environment protecting layer, 7 represents the intermediate layer, 71 is the adhesive layer, 8 represents the third dielectric layer, 9 represents the second recording layer, 10 represents the fourth dielectric layer, 101 represents a layer of the fourth dielectric layer, which is disposed on the surface of the recording layer, 102 represents a layer of the fourth dielectric layer, which is disposed on the surface of the reflective layer, 11 represents the second reflective layer, 12 represents the second substrate, 13 represents the transparent heat diffusing layer, 21 represents the first information substrate and 22 represents the second information substrate.

Examples of the material used usually for producing the first substrate include a glass, a ceramic and a resin. Among them, from the viewpoint point of the moldability and the cost, the resin is preferred. Specific examples of the resin include a polycarbonate resin, an acrylic resin, an epoxy resin, a polystyrene resin, an acrylonitrile-styrene copolymer, a polyethylene resin, a polypropylene resin, a silicone resin, a fluorine resin, an ABS resin and an urethane.

The thickness of the first substrate 1 is not restricted and determined depending on the wavelength of a laser used usually and light collecting properties of the pickup lens. For a CD using a laser having a wavelength of 780 nm, a first substrate having a thickness of 1.2 mm is used and for a DVD using a laser having a wavelength of 650 nm to 665 nm, a first substrate having a thickness of a 0.6 mm is used. For an optical disc using a blue laser having a wavelength of 405 nm, depending on the NA (Numerical Aperture) of the pickup lens, a first substrate having a thickness of 0.6 nm (in the case where the NA is 0.65) and a first substrate having a thickness of 1.1 mm on which a cover layer having a thickness of 0.1 mm is disposed (in the case where the NA is 0.85) are preferred.

As a material used for producing the first dielectric layer 2, a material having functions of preventing the deterioration of the recording layer 3 or the first recording layer 3,′ enhancing the adhesion strength between the first dielectric layer and the recording layer and improving recording properties of the recording layer is preferred. Examples of the material for the first dielectric layer include various oxides, nitrides, sulfides, carbides and mixtures thereof.

Generally, from the viewpoint of optical properties, thermal properties and the productivity, a mixture of ZnS and SiO₂ is frequently used.

The first dielectric layer 2 has preferably a thickness of 50 nm to 80 nm.

The materials used for producing the recording layer of a conventional optical recording medium are generally divided into a material having a composition Ge₂Sb₂Te₅ and the like which is a mixture of GeTe and Sb₂Te₃ and a material having a composition of Sb₇₀Te₃₀ and the like. In the both recording layers produced using both the above-noted materials, the amorphous mark is formed by the rapid cooling.

According to the present invention, for producing the recording layer 3 or the first recording layer 3′, a material comprising mainly an alloy represented by a composition formula GeₓSb_{y}Te_{z} (,wherein x, y, and z represent respectively an atomic % and x, y, and z satisfy the following equations: 3.5≦x≦10, 70≦y≦80 and z=100−x−y) is used. The recording layer 3 may have, like the below-mentioned second recording layer, a thickness of 5 nm to 16 nm; however since the first recording layer 3′ needs to have light transmission properties for recording the second recording layer, the first recording layer 3′ should have a thickness of 5 nm to 12 nm. In the above-noted equation, y should be 70 or more, because with respect to an optical disc having a large recording capacity and comprising a recording layer having a high recording density or a recording layer comprising plural layers, the recording and reproducing take much time and the phase-changing needs a high linear velocity. When y is more than 70, i.e., the amount of Sb is more than 70 atomic %, for example in the case of an optical disc using a blue laser having a wavelength of 405 nm and a pickup lens having a NA of 0.65, a recording layer having a recording speed of 36 Mbps (bit per second) can be obtained. On the contrary, when the amount of Sb is more than 80 atomic %, it becomes difficult to form an amorphous mark in the recording layer. With respect to the amount of Ge (x), for maintaining the preservation properties of the recording layer in a high temperature-high humidity atmosphere, the amount needs to be 3.5 atomic %. When the amount is more than 10 atomic %, the crystallization temperature of the recording layer is elevated to 200° C. or higher, the recording layer cannot be initialized by an usual initialization device. The recording layer may comprise another element than Ge, Sb and Te.

The second dielectric layer 4 and the fourth dielectric layer 10 comprise a compound oxide comprising at least one of a mixture of Nb₂O₅ and ZrO₂, a mixture of Nb₂O₅ and ZnO and a mixture of ZnO, Nb₂O₅ and ZrO₂ and these dielectric layer have the thickness of 10 nm to 30 nm. When the thickness is less than 10 nm, the thermal energy generated by the irradiating of the laser can not maintained in the recording layer, so that an amorphous mark having a contrast cannot be recorded in the recording layer. On the other hand, when the thickness is more than 30 nm, the thermal energy cannot be conducted to the reflective layer and the heat diffusing layer, so that an amorphous mark having a contrast also cannot be recorded in the recording layer.

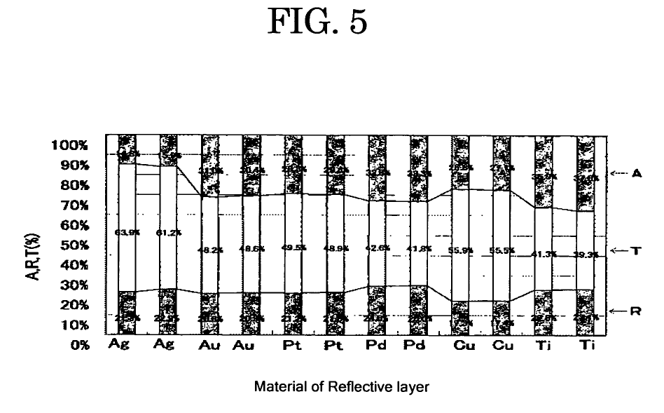

The first reflective layer 5 may comprise a metal material, such as Al, Au, Ag, Cu and Ta and an alloy thereof. As an additive to the above-noted metal material, Cr, Ti, Si, Cu, Ag, Pd and Ta can be used. In FIG. 5, data of A.R.T (A: absorption, R: reflectivity, T: transmissivity) measured for each mono-film (film thickness 10 nm) at optical wavelength 405 nm are shown in terms of pure Ag, Au, Pt, Pd, Cu and Ti. Data of two samples are shown for one metal material. FIG. 5 demonstrates that pure Ag exhibits the lowest absorption and is adapted to the material of the first reflective layer; next to this, Au, Pt and Pd are suitable that have similar reflectivities. On the other hand, Cu is inappropriate for the material of the reflective layer due to the low reflectivity in spite of the high transmissivity and lower absorption; Ti is also inappropriate for the material of the first reflective layer due to the low reflectivity in spite of the high transmissivity and lower absorption. Such a reflective layer can be produced according to various vapor phase growth methods, such as a vacuum metallizing method, a sputtering method, a plasma CVD method, a light CVD method, an ion plating method and an electron beam metallizing method. Among them, the sputtering method is excellent in the mass-productivity and the quality of the produced film.

As a material for producing the reflective layer according to the present invention, Ag and an Ag alloy are suitable. Here, “Ag alloy” means “an alloy material comprising Ag in an amount of 90 atomic % or more” and as an additive to the alloy material, Pd, Pt and Cu are preferred. The change in the thermal conductivity of the reflective layer due to addition of the above-noted additive doesn't become a problem of the whole optical information recording medium so long as the addition ratio of the additive is in the above-noted range.

The thickness of the first reflective layer 5 is properly selected depending on the application; however, since the first reflective layer 5 needs to maintain light transmission properties, the thickness is preferably as thin as possible, usually 5 nm to 12 nm.

The transparent heat diffusing layer 13 may comprise In₂O₃, SnO₂, ITO (a compound oxide comprising In₂O₃ and 5 to 10 atomic % of SnO₂) and IZO (a compound oxide comprising In₂O₃ and 5 to 20 atomic % of ZnO) which are widely used for producing a transparent conductive film. These materials have not only optical transparency, but also advantageous thermal conductivity. Particularly IZO has a small internal stress in the form of a thin film, so that mechanical properties of the optical disc produced using the transparent thermal diffusion layer comprising IZO are not impaired.

The thickness of the transparent thermal diffusion layer is 20 nm to 130 nm, usually 30 nm to 40 nm from the viewpoint of obtaining an improved reflectivity (by several % in comparison with another layer thickness) of the transparent thermal diffusion layer.

The intermediate layer 7 is produced using an ultraviolet curing resin. The thickness of the intermediate layer is 35±5 μm, when the intermediate layer is used for producing an optical recording medium using a blue laser having a wavelength of 405 nm as a laser for the recording and reproducing. In addition; when a 660 nm red wavelength of DVD system is used, a Laser Disc having two recording layers can be formed with making the film as 55±15 μm.

As a material for producing the third dielectric layer 8, a material having a same composition as that of a material for producing the first dielectric layer 2 can be used.; however it is appropriate that the third dielectric layer 8 has a thickness of around 60 nm to 70 nm. When the third dielectric layer 8 has a thickness of less than 60 nm, the third dielectric layer 8 cannot maintain thermal barrier properties, so that the intermediate layer 7 is sometimes subjected to thermal damage. On the other hand, when the third dielectric layer 8 has a thickness of more than 70 nm, the third dielectric layer 8 is subjected to thermal damage caused by the plasma during the film formation of the third dielectric layer 8, so that the mechanical properties of the whole optical information recording medium are largely changed.

As a material for producing the second recording layer 9, the same material for the recording layer as that for the first recording layer 3′ may be used. Since, while the first recording layer needs to have light transmission properties, the second recording layer needs not to have light transmission properties, the second recording layer 9 may have the thickness of 5 nm or more which is sufficient to the phase changing of the second recording layer, usually the thickness of 14 nm to 16 nm.

As a material for the second reflective layer 11, Ag or an Ag alloy is preferred. Since, while the first reflective layer 5 needs to have light transmission properties, the second reflective layer 11 needs not to have light transmission properties, the thickness of the second reflective layer 11 is not restricted and may be properly selected depending on the application. The thickness is usually 100 nm to 200 nm.

Further, as another disposing method of the second dielectric layer 4 and the fourth dielectric layer 10, the second dielectric layer 4 (or the fourth dielectric layer 10) may be disposed as the second dielectric layer 4 (or the fourth dielectric layer 10) which is divided into two layers, such as the dielectrics layer 41 (or 101) which is not contacted with the first reflective layer 5 (or the second reflective layer 11) and the dielectrics layer 42 (or 102) which is contacted with the reflective layer 5 (or the second reflective layer 11). Both the dielectric layer 42 and the dielectric layer 102 are produced using a compound oxide comprising at least one of a mixture of Nb₂O₅ and ZrO₂, a mixture of Nb₂O₅ and ZnO and a mixture of Nb₂O₅, ZrO₂ and ZnO.

The thickness of a dielectric layer which is contacted with a reflective layer is 3 nm or more and the total thickness of a dielectric layer which is contacted with a reflective layer and a dielectric layer which is not contacted with a reflective layer is 30 nm or less. Although the dielectric layer which is contacted with the reflective layer and has the thickness of only 2 nm functions as an anti-sulfuration layer so long as the dielectric layer is uniformly disposed, considering the case where the dielectric layer has ununiformity or oxygen atoms which invades from the vacuum apparatus for the film formation remains in the dielectric layer, the thickness of the dielectric layer is preferably 3 nm or more. The dielectric layer which is contacted with the reflective layer has the function as a layer for preventing the corrosion and deterioration of the reflective layer comprising Ag or an Ag alloy and when the thickness of the dielectric layer is less than 3 nm, the dielectric layer cannot usually perform the function. As a material for the dielectric layer which is not contacted with the reflective layer, various oxides, nitrides, sulfides, carbides and mixtures thereof may be used. From the viewpoint of the optical properties and thermal properties of the dielectric layer and the productivity of the optical recording medium, usually ZnS and SiO₂ are used.

The anti-environment layer 6 is disposed for improving the resistance to scuffing and corrosion resistance of the optical recording medium. When there is a time between the disposing of the reflective layer 5 and the disposing of the adhesive layer 71 or the intermediate layer 7, it is desirable to dispose the anti-environment layer 6 for improving the resistance to scuffing and corrosion resistance of the optical recording medium during the production thereof. However, when there is no time between the disposing of the reflective layer 5 and the disposing of the adhesive layer 71 or the intermediate layer 7, it is not necessary to dispose the anti-environment layer 6. Usually, the anti-environment layer 6 is disposed using an organic material, such as a resin according to a spray coating or a spinning coating. The anti-environment layer 6 has a thickness of several micrometers to tens of micrometers.

The adhesive layer 71 is disposed for adhesive-bonding the second substrate 12 to the anti-environment layer 6 (or the reflective layer 5). Usually, as a material for producing the adhesive layer 71, a thermosetting resin, a light (e.g., ultraviolet) curing resin or an adhesive seat is used. When the light curing resin is used, it is necessary that the second substrate is transparent and when the thermosetting resin is used, it is not necessary that the second substrate is transparent.

The material for producing the second substrate 12 is usually the same material as the material for producing the first substrate 1. To the optical properties of the material, importance is not attached, however, from the viewpoint of the moldability and the cost of the material, the material is preferably a polycarbonate resin or an acrylic resin. In Example of the present invention, as the second information substrate, a substrate having a continuous groove for the signal formed on the surface of the substrate which is the same groove as the groove formed on the surface of the first information substrate 21 is used. As another method, a method for forming a continuous groove for the signal in the intermediate layer 7 is a conventional method and lin this case, the groove for the signal on the second substrate is not necessary.

In FIG. 3 and FIG. 4, an example of the second dielectric layer and the fourth dielectric layer which comprise two layers is shown; however, optionally the dielectric layer may comprise three or more layers and a dielectric layer contacted with the reflective layer may be produced using a compound oxide comprising at least one of a mixture of Nb₂O_{5 and ZrO}₂, a mixture of Nb₂O₅ and ZnO and a mixture of Nb₂O₅, ZrO₂ and ZnO.

According to the present invention, the method of the present invention is applied limitedly to the optical recording medium comprising two recording layers; however, it is technically possible to apply the method of the present invention to the multi-layers optical recording medium comprising three or more recording layers.

In the optical recording medium having two recording layers, the reflectance when the focus is met in the first recording layer, and the reflectance when the focus is met in the second recording layer are both preferably 4% to 10%, and more preferably 5% to 9%. In the case where the reflectance is less than 4%, the signal cannot be easily distinguished from the reflectance from the substrate itself, since the substrate has a reflectance of 3%. In the case where the reflectance is more than 10%, especially in the case where that is the reflectance of the first recording layer, the optical energy which is transmitted and absorbed for the recording on the second recording layer becomes insufficient.

Here, “reflectance” is determined and obtained as follows. First of all, a metal film formed on a glass plate is subjected to a measurement of reflectance by means of a spectrophotometer, and also subjected to a measurement of a signal level by means of an optical disk evaluating device. Based upon the measured signal level as a reference, the measured signal levels of the first recording layer and the second recording layer are compared and converted to reflectances.

For example, a reflectance of pure Ag sputtered film having a thickness of 140 nm (1400 Å) formed on a glass plate having a thickness of 0.6 mm is measured at the wavelength of 660 nm by means of UV-Visible light spectrometer UV-2550 manufactured by Shimadzu Corporation, and the obtained reflectance is 87.7%. The signal level of the sputtered film on the glass plate is measured by an optical disk evaluation device using a laser beam having a wavelength of 660 nm, and the thus obtained signal level is determined as a reference reflectance of 87.7%. Sequentially, a signal level of the first recording layer or the second recording layer which is a subject to be measured is compared with the reference reflectance, and calculates the conversion value. This conversion value is determined as a reflectance of the recording layer.

(Recording and Reproducing method of Optical Recording Medium)

According to the recording and reproducing method of the optical recording medium according to the present invention, the recording and reproducing of the information are performed in the recording layer of the optical recording medium according to the present invention by irradiating a laser beam to the first substrate. More specifically, while the optical recording medium is rotated at a specified lineal speed or a specified constant angle velocity, to the rotating medium, a light for the recording, such as a semi-conductive laser (for example, having an oscillation wavelength of 350 nm to 700 nm) is irradiated through an objective lens at the surface of the cover substrate. The recording layer absorbs the irradiated light, thereby elevating the temperature of a part of the recording layer locally and in the recording layer, an amorphous mark is formed and optical properties of the recording layer are changed, so that information can be recorded in the recording layer. The reproducing of the recorded information in the recording layer is performed by detecting a reflected light which is produced at the recording layer in which information is recorded as noted above, when a laser beam is irradiated to the recording medium which is rotated at a specified lineal speed, at the surface of the first substrate.

According to the recording and reproducing method of the two-layered optical recording medium according to the present invention, the recording and reproducing of the information are performed in the recording layer of the two-layered optical recording medium according to the present invention by irradiating a laser beam to the first substrate.

More specifically, while the optical recording medium is rotated at a specified lineal speed or a specified constant angle velocity, to the rotating medium, a light for the recording, such as a semi-conductive laser (for example, having an oscillation wavelength of 350 nm to 700 nm) is irradiated through an objective lens at the surface of the cover substrate. The first and second recording layers absorb the irradiated light, thereby elevating the temperature of a part of the recording layer locally and in the first and second recording layers, an amorphous mark is formed and optical properties of the recording layer are changed, so that information can be recorded in the recording layer. The reproducing of the recorded information in the recording layer is performed by detecting a reflected light which is produced at the recording layer in which information is recorded as noted above, when a laser beam is irradiated to the recording medium which is rotated at a specified lineal speed, at the surface of the first substrate.

(Apparatus for Optical Recording and Reproducing of Optical Recording Medium)

The apparatus for the optical recording and reproducing according to the present invention is an apparatus for the optical recording and reproducing in which information is recorded and reproduced in the optical recording medium according to the present invention by irradiating a laser beam to the optical recording medium from a light source.

The apparatus for the optical recording and reproducing is not restricted and may be properly selected depending on the application. An example of the apparatus comprises a laser source from which a laser, such as a semi-conductive laser is irradiated, a collective lens collecting a irradiated laser to the optical recording medium fixed in a spindle, a detector of the laser detecting a portion of the laser irradiated from the laser source, an optical element leading the laser irradiated from the laser source to the collective lens and the laser detector, and optionally other units.

In the apparatus for the optical recording and reproducing, the laser irradiated from the laser source is led to the collective lens by the optical element and the laser collected by the collective lens is irradiated to the optical recording medium, so that the optical recording and reproducing in the optical recording medium is performed. In this procedure, a portion of the laser irradiated from the laser source is led to the laser detector, so that the laser detector can control the light amount of the laser irradiated from the laser source depending on the light amount of the laser detected by the laser detector.

The laser detector may output a detected light amount of the laser as a light amount signal in a voltage or current converted from the light amount by the laser detector.

Examples of the above-noted other units include a controlling unit. The controlling unit is not restricted so long as the unit can control each of the above-noted units and may be selected depending on the application. Examples of the controlling unit include a sequencer and a computer.

According to present invention, an optical recording medium having a high reflectivity which can improve the shelf reliability thereof without not only causing the corrosion and deterioration of the reflective layer produced using Ag or an Ag alloy as a material for the reflective layer, but also lowering the repeating number of the recording and erasing can be provided.

According to present invention, an two-layered optical recording medium having a large recording capacity which can improve the shelf reliability thereof without not only causing the corrosion and deterioration of the reflective layer having a high light-transmittance which is produced using Ag or an Ag alloy as a material for the reflective layer, but also lowering the repeating number of the recording and erasing can be provided.

According to present invention, by producing the second dielectric layer and fourth dielectric layer which respectively comprise plural layers, an optical recording medium which can obtain the shelf reliability thereof without changing largely conventional recording conditions can be provided.

Hereinbelow, the present invention will be described in more detail with reference to the following Examples and Comparative Examples, which should not be construed as limiting the scope of the present invention so long as the scope of the present invention does not deviate from the object of the present invention.

### EXAMPLE 1

On the first substrate 1 made of a polycarbonate having a thickness of 0.6 mm which has a wobbling continuous groove (having the land and groove having a track pitch of 0.46 μm for the tracking guide) formed on the surface of the substrate, each layer of the optical recording medium was disposed using a magnetron sputtering apparatus.

The first dielectric layer 2 was produced using a mixture of ZnS and SiO₂ (in molar ratio of 80:20) in such a manner that the layer has a thickness of 50 nm. The thermal conductivity of a mixture of ZnS and SiO₂ was measured and found to be 0.66 W/m·K.

The first recording layer 3 was produced using Ge₇Sb_{74.5}Te_{18.5} (coefficients represent the atomic %) in which the recording and erasing can be performed with a linear velocity of 6 m/s in such a manner that the first recording layer 3 has a thickness of 6 nm.

The second dielectric layer 4 was produced using an oxide mixture dielectric comprising ZrO₂ and Nb₂O₅ (in a mixing molar ratio of 30:70) in such a manner that the layer was shaped to a film having a thickness of 15 nm according to a sputtering film formation using a gas atmosphere comprising only Ar gas.

The first reflective layer 5 was produced using pure Ag in such a manner that the layer has a thickness of 6 nm.

Further, on the thin first reflective layer 5, using IZO (In₂O₃+ZnO in a molar ratio of 95:5), the transparent thermal diffusion layer 13 for recording an amorphous mark was formed in such a manner that the layer has a thickness of 40 nm. When there is a (no) time between the disposing of the thermal diffusion layer 13 and the intermediate layer 7, it is desired (unnecessary) that the anti-environment layer 6 is disposed.

As noted above, the first information substrate 21 was produced.

Next, the second information substrate 22 was produced in a reverse disposing order of each layer to that of producing the first information substrate 21, as follows.

First, on the second substrate made of a polycarbonate having a thickness of 0.6 mm which has a wobbling continuous groove (having the land and groove having a track pitch of 0.46 μm for the tracking guide) formed on the surface of the substrate, the second reflective layer 11 comprising an Ag₉₇Pd₃ alloy was disposed in such a manner that the layer has a thickness of 140 nm.

On the second reflective layer 11, the fourth dielectric layer 10 was produced using an oxide mixture dielectric comprising ZrO₂ and Nb₂O₅ (in a mixing molar ratio of 30:70) in such a manner that the layer was shaped to a film having a thickness of 18 nm according to a sputtering film formation using a gas atmosphere comprising only Ar gas.

On the fourth dielectric layer 10, the second recording layer 9 having a thickness of 14 nm was disposed using a phase-changing material having the same composition as that of the material used for producing the first recording layer 3′.

On the second recording layer, the third dielectric layer 8 having a thickness of 70 nm was disposed using a mixture of ZnS and SiO₂ having the same composition as that of a mixture of ZnS and SiO₂ used for producing the first dielectric layer 2, thereby obtaining the second information substrate 22.

Thereafter, the first information substrate 21 and the second information substrate 22 were adhesive-bonded to each other through the intermediate layer 7, thereby obtaining the two-layered optical recording medium. As the material for producing the intermediate layer 7, an ultraviolet curing resin (manufactured and sold by Sumitomo 3M Limited; trade name: EXP-106) is used and after the intermediate layer 7 was disposed by the spinning coating, the ultraviolet curing resin in the intermediate layer 7 was cured by irradiating an ultraviolet light to the first information substrate, thereby controlling the thickness of the intermediate layer 7 to 35±5 μm.

Next, using an initializing apparatus for the optical recording medium of phase-change type (manufactured and sold by Hitachi Computer Co., Ltd.; trade name: POP120-3Ra, having a central emission wavelength of LD of 810±10 nm and a spot size of about 1 μm×96±5 μm), the above-produced optical recording medium was initialized under the following conditions for a processing time of about 100 seconds.

The initialization of the first recording layer was performed by rotating the recording medium according to CLV (Constant Linear Velocity) with a linear velocity of 3.0 m/s and a feed rate of 36 μm/s, wherein the initializing range was in terms of a radius range of the disc 23 mm to 58 mm and the power of the laser was 800 mW.

The initialization of the second recording layer was performed in substantially the same manner as in the initialization of the first recording layer, except that the focus point was shifted in the thickness direction of the recording medium by 0.6 mm which is the thickness of the substrate from the focus point in the initialization of the first recording layer and the linear velocity and the power of the laser were changed respectively to 2.6 m/s and 1,000 mW.

The above-noted recording medium was evaluated using an optical disc evaluating apparatus (manufactured and sold by Pulse Tech Products Corporation; trade name: DDU 1,000) equipped with a pickup lens having NA 0.65 which can irradiate a semiconductor laser having a wavelength of 405 nm under the conditions where the linear density of the recording was 0.184 μm/bit (the clock frequency for the evaluation was 65.4 MHz) and random patterns of 3 T to 14 T were recorded. The result of the recording on the first recording layer is shown in Table 1.

As shown in Table 1, the initial jitter and reflectance of the first recording layer in the random recording of 3 T to 14 T was 6.7%, and 8%, respectively. After the 1000 times repeating of the recording and erasing, the jitter of the first recording layer was 8.6% (was maintained at the 8%s) and the change in properties of the recording medium after the repeating of the recording and erasing was advantageous. The second recording layer was recorded with the same pattern, and the initial jitter thereof was 7%. After the 1000 times repeating of the recording and erasing, the jitter of the second recording layer was 8.7%.

Next, the recording medium was subjected to the preservation test in a high temperature-high humidity atmosphere of 80° C., 85% RH and after 300 hours, the change of the recording medium was less than 1% and as the result of the visual appearance inspection of the recording medium using a physical microscope, there was no change, such as a change to black.

Further, in the above-noted recording medium, the recording was performed with controlling the area of an amorphous phase having a size of less than 0.26 μm in the scanning direction of the laser beam in seven steps and after the recoding, the sigma to dynamic range (SDR) of the recording medium was measured using the above-noted evaluation apparatus to which a pattern generation system and an evaluation system are attached. The recording conditions, such as the laser wavelength, NA and the recording linear velocity were the same as in the above-noted recording of the random pattern. The power of the reproducing light was 0.8 mW which is the upper limit value with which the reproducing light is not impaired. By recording with controlling the area of an amorphous portion in seven steps, the recording was performed with respect to eight values including the recording in the measurement of the reflectivity of the crystal, so that the recording medium having a recording capacity which is at least 1.5 times the recording capacity of the EFM (8-14) modulation recording of two values, could be obtained. Here, “SDR” means “a value obtained by dividing a standard deviation of reflectances in the above-noted seven steps by the difference between the maximum reflectance and the minimum reflectance and when SDR is 3% or less, it is a rate of error occurring by which the error can be corrected.

According to Examples, SDR of the recording medium was measured and as the result of the measurement, SDR of the first recording layer was found to be 2.9% and SDR of the second recording layer was found to be 2.8%.

Since the dielectric material used in Examples has a high transmittance at wavelengths for blue and the loss of the laser beam caused by the absorption by the dielectric material is little, a large vibrational amplitude of a reflection signal of the amorphous phase and crystalline phase during the recording of the first recording layer and second recording layer can be obtained, so that it is considered that SDR during the plural values recording can be lowered.

As the result of the preservation test of the plural values recording mark in a high temperature-high humidity atmosphere of 80° C., 85% RH, after the test for 300 hours, the change in SDR was less than 0.1% and it was no problem. As a result of the visual appearance inspection using a physical microscope, there was no change, such as a change to black.

### EXAMPLES 2 AND 3

In Examples 2 and 3, the two-layered optical recording medium was produced in substantially the same manner as in Example 1, except that the material and the thickness of the second dielectric layer of Example 1 was changed to the material and the thickness (respectively in Examples 2 and 3) shown in Table 1 and the produced recording material was evaluated in the same manner as in Example 1. The mixing rate of materials shown in Table 1 is expressed in the molar ratio.

As the result of the evaluation shown in Table 1, the jitter of each of the produced recording media in Examples 1 to 3 after the 1,000 times repeating of the recording and erasing was so low as 9% or less and the change of the preservation properties thereof after the test for 300 hours was 1% or less. Moreover, the results of the reflectances thereof were 8% and 7.5%, respectively.

### EXAMPLES 4 AND 5

On the first substrate 1 made of a polycarbonate having a thickness of 0.6 mm which has a specified guide groove formed on the surface of the substrate, each layer of the optical recording medium was disposed using a magnetron sputtering apparatus.

The first dielectric layer 2 was produced using a mixture of ZnS and SiO₂ (in molar ratio of 80:20) in such a manner that the layer has a thickness of 50 nm. The thermal conductivity of a mixture of ZnS and SiO₂ was measured and found to be 0.66 W/m·K.

The first recording layer 3 was produced using Ge_{3.5}Sb₇₂Te_{24.5} (coefficients represent the atomic %) in which the recording and erasing can be performed with a linear velocity of 6 m/s in such a manner that the first recording layer 3 has a thickness of 12 nm.

The second dielectric layer 4 was produced in Example 4 using an oxide mixture dielectric comprising ZrO₂ and Nb₂O₅ (in a mixing molar ratio of 30:70), in Example 5 using an oxide mixture dielectric comprising ZnO and Nb₂O₅ (in a mixing molar ratio of 30:70), in such a manner that the layer was shaped to a film having a thickness of 20 nm according to a sputtering film formation using a gas atmosphere comprising only Ar gas.

The first reflective layer 5 was produced using pure Ag in such a manner that the layer has a thickness of 140 nm.

Thereafter, on the first reflective layer 5, the anti-environment layer 6 comprising an organic film (an acrylate ultraviolet-curing resin) (manufactured and sold by Nippon Kayaku Co., Ltd.; trade name: KARAYAD DVD003) was disposed and the transparent thermal diffusion layer 13 for recording an amorphous mark was formed in such a manner that the layer has a thickness of 40 nm. When there is a (no) time between the disposing of the thermal diffusion layer 13 and the intermediate layer 7, it is desired (unnecessary) that the anti-environment layer 6 is disposed.

The thus obtained first information substrate was laminated with the second substrate 12 comprising a polycarbonate resin having a thickness of 0.6 mm through the adhesive layer 71, thereby obtaining the recording medium. Since the recording medium produced in Example 4 or Example 5 is a recording medium comprising one recording layer, as the second substrate 12, a substrate with no groove was used.

Next, the second information substrate 22 was produced in a reverse disposing order of each layer to that of producing the first information substrate 21, as follows.

The obtained recording medium was evaluated in substantially the same manner as in Example 1. The conditions for the initialization were also the same as for the first recording layer of Example 1.

The result of the evaluation is shown in Table 1. In Example 4 and Example 5, the initial jitter, the jitter after the 1,000 times repeating of the recording and erasing and preservation properties of the produced recording medium were advantageous.

### EXAMPLES 6 AND 7

The two-layered optical recording medium was produced in substantially the same manner as in Example 1, except that the produced recording medium comprises the first dielectric layer 2 having a thickness of 55 nm, the first recording layer 3′ having a thickness of 11 nm, the second dielectric layer 4 having a thickness of 14 nm and the second dielectric layer 4 having a thickness of 14 nm and comprising two layers, such as in Example 6 a layer having a thickness of 10 nm and comprising a mixture of ZnS and SiO₂ (in molar ratio of 80:20) and a layer having a thickness of 4 nm and comprising an oxide mixture dielectric of Nb₂O₅ and ZrO₂ (in mixing molar ratio of 30:70), in Example 7 a layer having a thickness of 11 nm and comprising a mixture of ZnS and SiO₂ (in molar ratio of 80:20) and a layer having a thickness of 3 nm and comprising an oxide mixture dielectric of Nb₂O₅ and ZrO₂ (in mixing molar ratio of 30:70).

The obtained recording medium was evaluated in substantially the same manner as in Example 1.

The result of the evaluation is shown in Table 1. In Example 6 and Example 7, the produced recording medium could be recorded with a recording linear velocity of 6 m/sec and as the result of the preservation test, the change in the jitter was less than 0.8% after 300 hours in the test and there was no problem. The results of the reflectances were both 8%.

### EXAMPLE 8

The recording medium was produced in substantially the same manner as in Example 4, except that the second dielectric layer 4 comprises two layers, such as a layer which is not contacted with the reflective layer, has a thickness of 17 nm and comprises a mixture of ZnS and SiO₂ (in molar ratio of 80:20) and a layer which is contacted with the reflective layer, has a thickness of 3 nm and comprises a compound oxide dielectric of ZrO₂ and Nb₂O₅ (in molar ratio of 30:70).

The obtained recording medium was evaluated in substantially the same manner as in Example 4.

The result of the evaluation is shown in Table 1. The initial jitter and the reflectance of the produced recording medium were respectively 7.0% and 17% and the jitter after the 1,000 times repeating of the recording and erasing was7.5%.

The recording medium was subjected to the preservation test in a high temperature-high humidity atmosphere of 80° C., 85% RH and as the result of the test, the change in the jitter after 300 hours in the test was less than 1% and there was no problem.

### COMPARATIVE EXAMPLE 1

The optical recording medium was produced in substantially the same manner as in Example 4, except that the materials for producing the second dielectric layer 4 was changed to a mixture of ZnS and SiO₂ which has the same composition as that of the material for producing the first dielectric layer 2 of Comparative Example 1.

However, the recording medium needs a linear velocity of 8.5 m/s.

The recording medium was initialized using a laser having a large output in the same manner as in Example 4 and evaluated using an optical disc evaluation apparatus equipped with an optical pickup comprising a source of a laser having a wavelength of 660 nm and a lens having NA of 0.65. The conditions for the evaluation, such as the recording linear density, the track pitch, the recording linear velocity and the signal modulation were same as in Example 4.

The result of the evaluation is shown in Table 1. The result is so advantageous that the initial jitter was 6.5% and the jitter after the 1000 times repeating of the recording and erasing was 7.9%.

The recording medium was subjected to the preservation test in a high temperature-high humidity atmosphere of 80° C., 85% RH and as the result of the test, after 50 hours in the test, the recording mark became unreadable (NG). In addition, as the result of the appearance inspection, a change to black was found in the Ag reflective layer and as the result of the observation in the depth direction of the recording medium using the Auger electron spectroscopy with respect to the portion of the change to black, sulfur was detected in the Ag reflective layer.

### COMPARATIVE EXAMPLE 2

The optical recording medium was produced in substantially the same manner as in Comparative Example 1, except that the second dielectric layer 4 comprises two layers, such as a layer which is not contacted with the recording layer, has a thickness of 16 nm and comprises a mixture of ZnS and SiO₂ having the same composition as that of the mixture of ZnS and SiO₂ used in Comparative Example 1 and a layer which is contacted with the reflective layer, has a thickness of 4 nm and comprises conductive SiC as anti-sulfuration layer.

The recording medium was initialized and evaluated in substantially the same manner as in Comparative Example 1.

The result of the evaluation is shown in Table 1. The initial jitter was 6.9% and the jitter after the 1,000 times repeating of the recording and erasing was 8.7%.

The recording medium was subjected to the preservation test in a high temperature-high humidity atmosphere of 80° C., 85% RH in substantially the same manner as in Comparative Example 1 and as the result of the test, after 150 hours in the test, a portion having a low reflectance was observed as the result of the oscillography (in the Rf wave pattern) (NG).

### COMPARATIVE EXAMPLES 3 AND 4

The optical recording medium was produced in substantially the same manner as in Example 4, except that the second dielectric layer 4 comprises two layers, such as a layer which is not contacted with the recording layer, has a thickness of 16 nm and comprises a mixture of ZnS and SiO₂ having the same composition as that of the mixture of ZnS and SiO₂ used in Comparative Example 1 and a layer which is contacted with the reflective layer, has a thickness of 2.0 nm (in Comparative Example 3), 2.8 nm (in Comparative Example 4) and comprises a compound oxide dielectric of ZrO₂ and Nb₂O₅ (in molar ratio of 30:70) as anti-sulfuration layer.

The obtained recording medium was initialized and evaluated in substantially the same manner as in Example 1.

The result of the evaluation is shown in Table 1. In Examples 9 and 10, the initial jitter and the jitter after the 1,000 times repeating of the recording and erasing of the produced recording medium were advantageous.

The recording medium was subjected to the preservation test in a high temperature-high humidity atmosphere of 80° C., 85% RH and in Examples 9 and 10, as the result of the test, after each preservation time in the test, a portion having a low reflectance was observed as the result of the oscillography (in the Rf wave pattern) (NG).

### EXAMPLES 9-11

The two-layered optical recording medium was produced in substantially the same manner as in Example 1, except that the thickness of the first recording layer was changed to 5 nm (in Example 9), 9 nm (in Example 10), and 12 nm (in Example 11).

The obtained recording medium was initialized, and then evaluated in substantially the same manner as in Example 1.

The result of the evaluation is shown in Table 2. In Examples 9-11, as the recording conditions were adjusted corresponding to the change in the thickness, the properties thereof changed. However, the initial jitter and DOW jitter were both appropriately 9%. Therefore, the recording and reproducing of the data were able to be performed.

### COMPARATIVE EXAMPLES 5 AND 6

The two-layered optical recording medium was produced in substantially the same manner as in Example 1, except that the thickness of the first recording layer was changed to 4.8 nm (in Comparative Example 5), and 12.2 nm (in Comparative Example 6).

The obtained recording medium was initialized, and then evaluated in substantially the same manner as in Example 1.

The result of the evaluation is shown in Table 2. In Comparative Example 5, although the recording conditions were appropriately adjusted corresponding to the change in the thickness, a sufficient initial jitter could not be obtained in Comparative Example 5. Moreover, DOW10000 jitter thereof was over 20%. In Comparative Example 6, the initial jitter and DOW jitter were both preferable, but the recording on the second recording layer became difficult, and the initial jitter and DOW jitter of the second recording layer were both over 10%. Here, a first recording layer was separately prepared in substantially the same manner to the above, and the transmittance thereof was measured. The transmittance of the first recording layer was 35%.

### EXAMPLES 12-14

The two-layered optical recording medium was produced in substantially the same manner as in Example 1, except that the thickness of the first recording layer was changed to 5 nm (in Example 12), 9 nm (in Example 13), and 16 nm (in Example 14).

The obtained recording medium was initialized, and then evaluated in substantially the same manner as in Example 1.

The result of the evaluation is shown in Table 3. In Examples 12-14, as the recording conditions were adjusted corresponding to the change in the thickness, the properties thereof changed, but the initial jitter and DOW jitter were both appropriately 9%. Therefore, recording and reproducing of the data was able to be performed.

### COMPARATIVE EXAMPLES 7 AND 8

The two-layered optical recording medium was produced in substantially the same manner as in Example 1, except that the thickness of the first recording layer was changed to 4.8 nm (in Comparative Example 7), and 16.2 nm (in Comparative Example 8).

The obtained recording medium was initialized, and then evaluated in substantially the same manner as in Example 1.

The result of the evaluation is shown in Table 3. In Comparative Example 5, although the recording conditions were appropriately adjusted corresponding to the change in the thickness, a sufficient initial jitter could not be obtained in Comparative Example 7. Moreover, DOW10000 jitter thereof was over 20%. In Comparative Example 8, the recording power became insufficient, and thus the initial jitter and DOW jitter were both over 10%.

### EXAMPLES 15 AND 16

The two-layered optical recording medium was produced in substantially the same manner as in Example 5, except that the thickness of the first recording layer was changed to 10 nm (in Example 15), and 30 nm (in Example 16).

The obtained recording medium was initialized, and then evaluated in substantially the same manner as in Example 1.

The result of the evaluation is shown in Table 4. In Examples 15 and 16, as the recording conditions were adjusted corresponding to the change in the thickness, the properties thereof changed, but the initial jitter and DOW jitter were both appropriately 9%. Therefore, recording and reproducing of the data was able to be performed.

### COMPARATIVE EXAMPLES 9 AND 10

The two-layered optical recording medium was produced in substantially the same manner as in Example 1, except that the thickness of the first recording layer was changed to 9.8 nm (in Comparative Example 9), and 30.2 nm (in Comparative Example 10).

The obtained recording medium was initialized, and then evaluated in substantially the same manner as in Example 1.

The result of the evaluation is shown in Table 4. In Comparative Example 9, the recording power became insufficient, and thus the initial jitter was over 10%. However, the variation to the DOW1000 jitter was within 1%. In Comparative Example 10, although the recording power was sufficient, the DOW1000 jitter was over 10%.

### EXAMPLE 17

The two-layered optical recording medium was produced in substantially the same manner as in Example 1, except that the thickness of each the first dielectric layer, the first recording layer (L0 layer), the first reflective layer, the third dielectric layer, and the second recording layer (L1 layer) were changed.

The obtained recording medium was initialized in substantially the same manner as in Example 1, and the initial jitter thereof was measured.

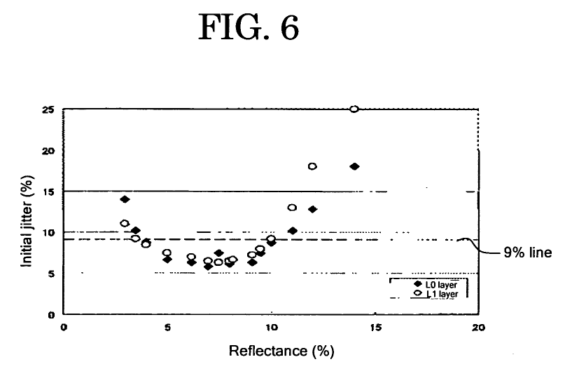

The result of the initial jitter is shown in FIG. 6. Note that, in the case where the reflectances of both L0 and L1 layers were outside the range of 7-8%, the information layer containing a recording layer having low reflectance of less than 7%, and the information layer containing a recording layer having a high reflectance of more than 8% were laminated, and one of them was determined as L0 layer to obtain the data presented in FIG. 6.

As shown in FIG. 6, the reflectance to have the jitter of 9% or less was in the range of 4% to 10%. In the case where the reflectance was less than 4% and more than 10%, the jitter of both L0 and L1 layers were increased.

### EXAMPLE 18, AND COMPARATIVE EXAMPLE 11

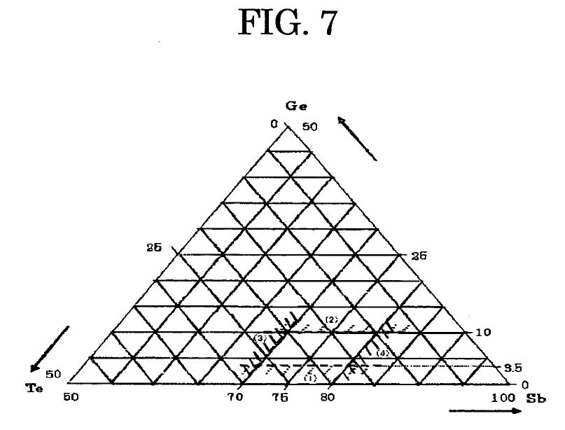

In Comparative Example 11, the two-layered optical recording medium was produced in substantially the same manner as in Example 1, except that the composition of the recording layer was changed to that in (i)-(4) regions [(1) a region where Ge is less than 3.5 atomic %; (2) a region where Ge is more than 10 atomic %; (3) a region where Sb is less than 70 atomic %; and (4) a region where Sb is more than 80 atomic %] as shown in FIG. 7. Note that these compositions were other than the composition defined in the present invention.

The obtained recording medium was initialized and then evaluated in substantially the same manner as in Example 1. As a result, it was found that there were problems as shown in Table 5.

In Example 8, the two-layered optical recording medium was produced by using the composition of the recording layer in a region surrounding (1)-(4) regions. Note that the composition in such the region was the composition defined in the present invention.

The obtained recording medium was initialized and then evaluated in substantially the same manner to the above. As a result, it was found that no problems as shown in Table 5 were occurred, and the variation of the jitter was kept within 1% at the stability test which was performed under the conditions of high temperature and high humidity of 85° C., 85%RH for more than 300 hours. Moreover, the recording at the linear velocity of 6 m/s or more was achieved.

In the case of the two-layered optical recording medium, it is necessary to record on a recording layer which is present further side relative to the incidence side, and thus the recording properties of the recording layer whish is present by the incident side have some restrictions. However, an optical recording medium having one recording layer does not have such restrictions, and thus the recording layer in such the optical recording medium can be produced with any composition which can be used for the recording layer by the incident side.

### EXAMPLE 19-26, AND COMPARATIVE EXAMPLES 12-15

The two-layered optical recording medium was produced in substantially the same manner as in Example 1, except that the composition of the recording layer was changed to that shown in Table 6.

The obtained recording medium was initialized, and then evaluated in substantially the same manner as in Example 1.

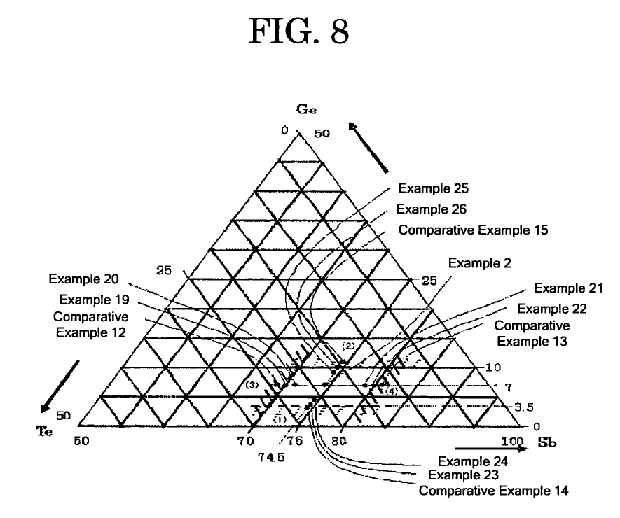

The result of the evaluation is shown in Table 6. These are a part of the data which supports the results of the numerical ranges obtained in Example 18 and Comparative Example 11 (refer to FIG. 7). The composition of the recording layer for each optical recording mediums was shown in FIG. 8. Note that evaluation standards of the high temperature high humidity storage test, and abbreviations are the same to those in Table 1. In the reproducing light test which was not performed in Example 1, “no change” defined the condition that the variation of the jitter after reproducing 100,000 times with the reproducing power of 0.8 mW was kept within 0.5%.

### EXAMPLE 27

The two-layered optical recording medium was produced in substantially the same manner as in Example 1, except that the recording material- composition was changed to Ge₆Sb₇₃Te₂₁, the thickness of the first recording layer (L0 layer) was varied in the range of 3 nm to 18 nm, and the thickness of the second layer (L1 layer) was changed to 11 nm.

The obtained recording medium was initialized, and the initial jitter there of was measured in substantially the same manner as in Example 1.

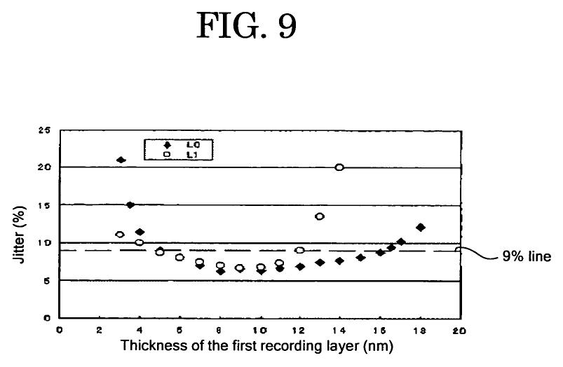

The result of the initial jitter is shown in FIG. 9.

As the properties of the L0 layer, a suitable jitter property, such as 9% or less, could be obtained when the thickness was from 5 nm to 16 nm, but the jitter was increased when the thickness was less than 5 nm and more than 16 nm.

The jitter of the first information layer was plotted in the case where the first information layer containing the L0 layer was bonded to the second information layer containing the L1 layer having a thickness of 11 nm via an adhesive layer. The jitter of the second information layer was changed corresponding to the thickness of the L0 layer. Specifically, when the thickness was 5 nm to 12 nm, the excellent jitter property, such as 9% or less could be obtained, and when the thickness was over 12 nm, the jitter was increased. This was because the light energy which passed through the first information layer decreased by the time it arrived at the second information layer. As a result, it was found that the thickness of L0 should be determined after considering the influence to the second information layer as well as the recording properties of the first information layer.

### EXAMPLE 28-30

The two-layered optical recording medium was produced in substantially the same manner as in Example 1, except that the material of the first reflective layer was changed to Au, Pt or Pd.

The obtained recording medium was initialized in substantially the same manner as in Example 1, and then subjected to the measurement of the reflectance and the measurement of the initial jitter in accordance with a binary random recording in substantially the same manner as in Example 1.

The result of the evaluation is shown in Table 7. In Examples 28-30, the variations between the reflectance and jitter of the medium having the first reflective layer formed of Au, Pt or Pd and the reflectance and jitter of the medium having the first reflective layer formed of Ag were kept within less than 1%. Therefore, it was found that mediums having substantially the same properties could be obtained by usging the reflective materials of Au, Pt, or Pd.

### COMPARATIVE EXAMPLE 16

The two-layered optical recording medium was produced in substantially the same manner as in Example 1, except that the material of the first reflective layer was changed to Cu.

The obtained recording medium was initialized in substantially the same manner as in Example 1, and then subjected to the measurement of the reflectance and the measurement of the initial jitter in accordance with a binary random recording in substantially the same manner as in Example 1.

In the case where Cu was used as a material of the reflective layer, the transmittance was high and the absorbance was low at the wavelength of 405 nm as shown in FIG. 5, but the reflectance thereof was low which was not suitable for the material of the reflective layer. The obtained reflectance was appropriately 70%, and a conversion value was less than 5 when compared with, as a reference reflectance of 87.7%, a signal level of pure Ag sputtered film having a thickness of 140 nm (1400 Å) formed on a glass plate having a thickness of 0.6 mm measured by means of an optical disk evaluation device.

The initial jitter in accordance with the binary random recording was over 9%. The results are shown in Table 7.

### COMPARATIVE EXAMPLE 17

The two-layered optical recording medium was produced in substantially the same manner as in Example 1, except that the material of the first reflective layer was changed to Ti.

The obtained recording medium was initialized in substantially the same manner as in Example 1, and then subjected to the measurement of the reflectance and the measurement of the initial jitter in accordance with a binary random recording in substantially the same manner as in Example 1.

In the case where Ti was used as a material of the reflective layer, the reflectance was low at the wavelength of 405 nm as shown in FIG. 5, but the absorbance of the reflective layer itself was high so that the irradiated optical energy could not efficiently used. Moreover, the transmittance was low, and thus it was suspected that the recording on the second information layer would become difficult. Therefore, it was not suitable for the material of the reflective layer. The obtained reflectance was appropriately 150% compared to a reflectance in the case of the reflective layer of Ag, and the reflectance was over 10% by using the same evaluation as in Comparative Example 12. Moreover, the initial jitter in accordance with the binary random recording was over 9%. The results are shown in Table 7.

TABLE 1

| | | | | | Recording | | | | | |
|---|---|---|---|---|---|---|---|---|---|---|
| | | Thickness | | Thickness | Linear | Recording | Initial | Reflec- | Repeating | Preservation |
| | Second Dielectric | of SDL*¹ | Fourth Dielectric | of FDL*² | Velocity | Power | Jitter | tance | Properties*³ | Properties |
| | Layer | (nm) | Layer | (nm) | (m/s) | (mw) | (%) | (%) | Jitter (%) | 80° C.-85% RH |
| Ex. 1 | ZrO₂ + Nb₂O₅ | 15 | ZrO₂ + Nb₂O₅ | 18 | 6 | 14 | 6.7 | 8 | 8.6 | 300HOK |
| | (30:70) | | (30:70) | | | | | | | |
| Ex. 2 | ZnO + Nb₂O₅ | 15 | ZrO₂ + Nb₂O₅ | 18 | 6 | 14 | 6.2 | 8 | 7.9 | 300HOK |
| | (30:70) | | (30:70) | | | | | | | |
| Ex. 3 | ZnO + ZrO₂ + Nb₂O₅ | 17 | ZrO₂ + Nb₂O₅ | 18 | 6 | 14 | 7.5 | 7.5 | 8.7 | 300HOK |
| | (20:30:50) | | (30:70) | | | | | | | |
| Ex. 4 | ZrO₂ + Nb₂O₅ | 20 | none | none | 8.5 | 12 | 6.5 | 17 | 8.0 | 400HOK |
| | (30:70) | | | | | | | | | |
| Ex. 5 | ZnO + Nb₂O₅ | 20 | none | none | 8.5 | 12 | 7.8 | 16 | 8.9 | 400HOK |
| | (30:70) | | | | | | | | | |
| Ex. 6 | ZnS + SiO₂(80:20)/ | 10/4 | none | none | 6 | 14 | 7.6 | 8 | 8.6 | 300HOK |
| | ZrO₂ + Nb₂O₅ | | | | | | | | | |
| | (30:70) | | | | | | | | | |
| Ex. 7 | ZnS + SiO₂(80:20)/ | 11/3 | none | none | 6 | 14 | 6.4 | 8 | 8.0 | 300HOK |
| | ZrO₂ + Nb₂O₅ | | | | | | | | | |
| | (30:70) | | | | | | | | | |
| Ex. 8 | ZnS + SiO₂(80:20)/ | 17/3 | none | none | 8.5 | 14 | 7.0 | 17 | 7.5 | 400HOK |
| | ZrO₂ + Nb₂O₅ | | | | | | | | | |
| | (30:70) | | | | | | | | | |
| Com. | ZnS + SiO₂ | 20 | none | none | 8.5 | 12 | 6.5 | 17 | 7.9 | 50HNG |
| Ex. 1 | (80:20) | | | | | | | | | |
| Com. | ZrO₂ + Nb₂O₅ | 16/4 | none | none | 6 | 12 | 6.9 | 15 | 8.7 | 100HOK |
| Ex. 2 | (30:70)/SiC | | | | | | | | | 150HNG |
| Com. | ZnS + SiO₂(80:20)/ | 18/2 | none | none | 8.5 | 12 | 6.7 | 17 | 8.1 | 50HNG |
| Ex. 3 | ZrO₂ + Nb₂O₅ | | | | | | | | | |
| | (30:70) | | | | | | | | | |
| Com. | ZnS + SiO₂(80:20)/ | 17.2/2.8 | none | none | 8.5 | 12 | 6.8 | 17 | 8.3 | 50HOK |
| Ex. 4 | ZrO₂ + Nb₂O₅ | | | | | | | | | 100HNG |
| | (30:70) | | | | | | | | | |

*¹Second Dielectric Layer
*²Fourth Dielectric Layer
*³Measured as a jitter (%) after the 1,000 times repeating of the recording and erasing

TABLE 2

| | First recording | First recording layer | | | Second recording layer | | |
|---|---|---|---|---|---|---|---|
| | layer | Thickness | Initial | DOW 1000 | Thickness | Initial | DOW 1000 |
| | composition | (nm) | jitter (%) | jitter (%) | (nm) | jitter (%) | jitter (%) |
| Com. Ex. 5 | Ge₇Sb_{74.5}Te_{18.5} | 4.8 | 9.2 | 20< | 14 | 6.3 | 8.5 |
| Ex. 9 | | 5 | 7.5 | 8.9 | | 6.5 | 8.5 |
| Ex. 1 | | 6 | 6.7 | 8.6 | | 7.0 | 8.7 |
| Ex. 10 | | 9 | 6.5 | 8.6 | | 7.8 | 8.8 |
| Ex. 11 | | 12 | 6.3 | 8.5 | | 8.6 | 9.3 |
| Com. Ex. 6 | | 12.2 | 6.2 | 8.5 | | 11.0 | 15.0 |

TABLE 3

| | First | | | | | | |
|---|---|---|---|---|---|---|---|
| | recording | First recording layer | | | Second recording layer | | |
| | layer | Thickness | Initial | DOW 1000 | Thickness | Initial | DOW 1000 |
| | composition | (nm) | jitter (%) | jitter (%) | (nm) | jitter (%) | jitter (%) |
| Com. Ex. 7 | Ge₇Sb_{74.5}Te_{18.5} | 6 | 6.7 | 8.6 | 4.8 | 9.5 | 20< |
| Ex. 12 | | | | | 5 | 8.5 | 9.4 |
| Ex. 13 | | | | | 9 | 7.8 | 8.8 |
| Ex. 1 | | | | | 14 | 7.0 | 8.7 |
| Ex. 14 | | | | | 16 | 7.9 | 9.2 |
| Com. Ex. 8 | | | | | 16.2 | 11.0 | 13.0 |

TABLE 4

| | | | | Jitter of recording layer | |
|---|---|---|---|---|---|
| | Second dielectric | Thickness of second | Recording | Initial | DOW 1000 |
| | film composition | dielectric film | power (mW) | jitter (%) | jitter (%) |
| Com. Ex. 9 | ZrO₂ + Nb₂O₅ | 9.8 | 12 | 12.0 | 12.9 |
| | (30:70) | | | | |
| Ex. 15 | | 10 | | 8.3 | 9.0 |
| Ex. 5 | | 20 | | 7.8 | 8.9 |
| Ex. 16 | | 30 | | 8.3 | 9.0 |
| Com. Ex. 10 | | 30.2 | | 8.5 | 10< |

TABLE 5

| Region | Notes | Properties of the medium |
|---|---|---|
| (1) | Ge: less than | Reproducing light starts deteriorating with |
| | 3.5 atomic % | the reproducing power of 0.8 mW or more, and |
| | | the signal output of the medium is lowered |
| | | with time. |
| (2) | Ge: more than | Crystallization temperature becomes 200° C. |
| | 10 atomic % | or more, the recording power increases, and |
| | | thus recording cannot be performed. |
| (3) | Sb: less than | Transition linear velocity becomes 6 m/s or |
| | 70 atomic % | less, and the recording cannot be performed at |
| | | the practical speed. |
| (4) | Sb: more than | Transition linear velocity increases, but the |
| | 80 atomic % | crystallization temperature is lowered to |
| | | 150° C. or less, and thus the stability |
| | | decreases. |

TABLE 6

| | | | | Initial | | Reproducing | |
|---|---|---|---|---|---|---|---|
| | Recording layer composition | | | jitter | DOW1000 | light test | Stability |
| | Ge (at %) | Sb(at %) | Te(at %) | (%) | jitter (%) | 0.8 mW × 100000 | (80° C., 85% RH) |
| Com. Ex. 12 | 7 | 69 | 24 | 9.3 | 10.2 | No change | 300H-OK |
| Ex. 19 | 7 | 70 | 23 | 8.5 | 9 | No change | 300H-OK |
| Ex. 20 | 7 | 71 | 22 | 7.9 | 8.4 | No change | 300H-OK |
| Ex. 21 | 7 | 79 | 14 | 7.9 | 8.4 | No change | 300H-OK |
| Ex. 22 | 7 | 80 | 13 | 8.3 | 8.7 | No change | 300H-OK |
| Com. Ex. 13 | 7 | 81 | 12 | 8.6 | 9.3 | No change | 200H-lowered |
| Com. Ex. 14 | 3.3 | 74.5 | 22.2 | 7.6 | 9.3 | Jitter increased | 150H-lowered |
| | | | | | | by 0.9% | |
| Ex. 23 | 3.5 | 74.5 | 22 | 7.5 | 8.9 | No change | 300H-OK |
| Ex. 24 | 3.7 | 74.5 | 21.8 | 7.4 | 8.7 | No change | 300H-OK |
| Ex. 2 | 7 | 74.5 | 18.5 | 6.7 | 7.9 | No change | 300H-OK |
| Ex. 25 | 9 | 74.5 | 16.5 | 7.6 | 8.4 | No change | 400H-OK |
| Ex. 26 | 10 | 74.5 | 15.5 | 8.3 | 9 | No change | 400H-OK |
| Com. Ex. 15 | 11 | 74.5 | 14.5 | 9.4 | 10 | No change | 400H-OK |

TABLE 7

| | Reflective layer | | |
|---|---|---|---|
| | material | Reflectance (%) | Initial jitter (%) |
| Ex. 1 | Ag | 8.0 | 6.7 |
| Ex. 28 | Au | 7.2 | 6.2 |
| Ex. 29 | Pt | 7.7 | 6.5 |
| Ex. 30 | Pd | 8.7 | 6.9 |
| Com. Ex. 16 | Cu | 4.8 | 9.5 |
| Com. Ex. 17 | Ti | 12.1 | 15.6 |

what is claimed is:

1. An optical recording medium comprising:
a first substrate,
a first dielectric layer,
a recording layer,
a second dielectric layer, and
a reflective layer in this order,
wherein the recording layer comprises the composition represented by the composition formula: GeₓSb_{y}Te_{z} (wherein x, y and z represent respectively an atomic %, and x, y and z satisfy respectively the following equations: 3.5≦x≦10, 70≦y≦80 and z=100−x−y) and the second dielectric layer comprises a compound oxide comprising at least Nb₂O₅.

2. The optical recording medium according to claim 1,
wherein the amount of Nb₂O₅ in the second dielectric layer is 50 mole % or more.

3. The optical recording medium according to claim 1,
wherein the second dielectric layer comprises at least one of ZrO₂ and ZnO.

4. The optical recording medium according to claim 1,
wherein the second dielectric layer comprises any one of a mixture of Nb₂O₅ and ZrO₂ and a mixture of Nb₂O₅ and ZnO.

5. The optical recording medium according to claim 1,
wherein the second dielectric layer comprises at least two layers and a layer of the two layers which is contacted with the reflective layer comprises a compound oxide comprising at least Nb₂O₅ and another layer of the two layers which is not contacted with the reflective layer comprises another dielectric material than Nb₂O₅, ZrO₂ and ZnO.

6. The optical recording medium according to claim 1,
wherein a layer of the second dielectric layer which is contacted with the reflective layer has a thickness of 3 nm or more.

7. The optical recording medium according to claim 1,
wherein the second dielectric layer has a total thickness of 10 nm to 30 nm.

8. The optical recording medium according to claim 1,
wherein a crystalline phase of the recording layer is in at least one of an unrecorded state and an erased state and an amorphous phase of the recording layer is in a recorded state.

9. The optical recording medium according to claim 1,
wherein the recording layer has a thickness of 5 nm to 16 nm.

10. The optical recording medium according to claim 1,
wherein the reflective layer comprises at least one of Ag and an Ag alloy.

11. A two-layered optical recording medium comprising:
a first information layer which comprises:
a first substrate,
a first dielectric layer,
a first recording layer,
a second dielectric layer, and
a first reflective layer in this order;
an intermediate layer; and
a second information layer which comprises:
a second substrate,
a second reflective layer,
a fourth dielectric layer,
a second recording layer, and
a third dielectric layer in this order,
wherein the first reflective layer of the first information layer is disposed on a surface of the intermediate layer and the second reflective layer of the second information layer is disposed on another surface of the intermediate layer,
and wherein the first recording layer and the second recording layer comprise a composition represented by the formula: GeₓSb_{y}Te_{z} (wherein x, y and z represent respectively an atomic % and x, y and z satisfy respectively the following equations: 3.5≦x≦10, 70≦y≦80 and z=100−x−y) and the second dielectric layer and the fourth dielectric layer comprise a compound oxide comprising at least Nb₂O₅.

12. The two-layered optical recording medium according to claim 11,
wherein the amount of Nb₂O₅ in the second dielectric layer or in the fourth dielectric layer is 50 mole % or more.

13. The two-layered optical recording medium according to claim 11,
wherein the second dielectric layer and the fourth dielectric layer comprise at least one of ZrO₂ and ZnO.

14. The two-layered optical recording medium according to claim 11,
wherein the second dielectric layer and the fourth dielectric layer comprise any one of a mixture of Nb₂O₅ and ZrO₂ and a mixture of Nb₂O₅ and ZnO.

15. The two-layered optical recording medium according to claim 11,
wherein the second dielectric layer comprises at least two layers and a layer of the second dielectric layer which is contacted with the first reflective layer comprises a compound oxide comprising at least Nb₂O₅ and another layer of the second dielectric layer which is not contacted with the first reflective layer comprises another dielectric material than Nb₂O₅, ZrO₂ and ZnO.

16. The two-layered optical recording medium according to claim 11,
wherein the fourth dielectric layer comprises at least two layers and a layer of the fourth dielectric layer which is contacted with the second reflective layer comprises a compound oxide comprising at least Nb₂O₅ and another layer of the fourth dielectric layer which is not contacted with the second reflective layer comprises another dielectric material than Nb₂O₅, ZrO₂ and ZnO.

17. The two-layered optical recording medium according to claim 11,
wherein a layer of the second dielectric layer which is contacted with the first reflective layer and a layer of the fourth dielectric layer which is contacted with the second reflective layer have a thickness of 3 nm or more.

18. The two-layered optical recording medium according to claim 11,
wherein at least one of the second dielectric layer and the fourth dielectric layer has a total thickness of 10 nm to 30 nm.

19. The two-layered optical recording medium according to claim 11,
wherein a crystalline phase of the first recording layer and the second recording layer is in at least one of an unrecorded state and an erased state, and an amorphous phase of the first recording layer and the second recording layer is in a recorded state.

20. The two-layered optical recording medium according to claim 11,
wherein both the first recording layer and the second recording layer have a reflectance of 4% to 10%.

21. The two-layered optical recording medium according to claim 11,
wherein at least one of the first reflective layer and the second reflective layer comprises at least one selected from the group consisting of Ag, Pd, Pt, Au and an alloy thereof.

22. The two-layered optical recording medium according to claim 11,
wherein the optical recording medium comprises a thermal diffusion layer between the first reflective layer and the intermediate layer.

23. A recording and reproducing method of a two-layered optical recording medium comprising:
performing at least one of the recording and reproducing of the information by irradiating a laser beam from the first substrate to the recording layer of the optical recording medium, wherein the optical recording medium comprises,
a first substrate,
a first dielectric layer,
a recording layer,
a second dielectric layer, and
a reflective layer in this order,
wherein the recording layer comprises the composition represented by the composition formula: GeₓSb_{y}Te_{z} (wherein x, y and z represent respectively an atomic %, and x, y and z satisfy respectively the following equations: 3.5≦x≦10, 70≦y≦80 and z=100−x−y) and the second dielectric layer comprises a compound oxide comprising at least Nb₂O₅.

24. A recording and reproducing method of a two-layered optical recording medium comprising:
performing at least one of the recording and reproducing of the information by irradiating a laser beam from the first substrate to the recording layer of the optical recording medium according to claim 11.

25. An optical recording and reproducing apparatus comprising:
a light source from which a laser beam is irradiated to an optical recording medium for performing at least one of the recording and reproducing of the information in the optical recording medium,
wherein the optical recording medium comprises,
a first substrate,
a first dielectric layer,
a recording layer,
a second dielectric layer, and
a reflective layer in this order,
wherein the recording layer comprises the composition represented by the composition formula: GeₓSb_{y}Te_{z} (wherein x, y and z represent respectively an atomic %, and x, y and z satisfy respectively the following equations: 3.5≦x≦10, 70≦y≦80 and z=100−x−y) and the second dielectric layer comprises a compound oxide comprising at least Nb₂O₅.
